(19) United States
(12) Patent Application Publication
(10) Pub. No.: US 2021/0214518 A1
(43) Pub. Date: Jul. 15, 2021

(54) IMPROVED METHOD OF RECYCLING POLYURETHANE MATERIALS

(71) Applicants: Thomas Vanbergen, Schulen (BE); Dirk De Vos, Holsbeek (BE); Isabel Verlent, Wetteren (BE); Joke De Geeter, Wetteren (BE); Bart Haelterman, Wetteren (BE)

(72) Inventors: Thomas Vanbergen, Schulen (BE); Dirk De Vos, Holsbeek (BE); Isabel Verlent, Wetteren (BE); Joke De Geeter, Wetteren (BE); Bart Haelterman, Wetteren (BE)

(73) Assignee: RECTICEL, Brussel (BE)

(21) Appl. No.: 17/054,905

(22) PCT Filed: May 16, 2019
(86) PCT No.: PCT/EP2019/062625

§ 371 Date: Nov. 12, 2020

(30) Foreign Application Priority Data
May 17, 2018 (EP) 18173062.3

(51) Int. Cl. C08J 11/24; C08K 5/00; C08K 5/053; B01J 31/12

(52) U.S. Cl. CPC C08J 11/24; C08K 5/0033; C08J 2375/04; B01J 31/122; C08K 5/053

(57) ABSTRACT

A method for alcoholising polyurethane (PUR) materials made from at least one polyol compound having a hydroxyl value X and at least one polyisocyanate compound; wherein the method includes contacting the polyurethane material with at least one alcoholising compound, thereby forming a reaction mixture (M₀) and allowing the polyurethane material and the alcoholising compound to react in the reaction mixture (M₀), thereby forming a mixture (M); allowing the mixture (M) to separate into at least two immiscible phases; wherein at least one phase is characterized by a hydroxyl value Y wherein Y≤3.5*X; wherein at least one alcoholising compound is characterized by a hydroxyl functionality of at least 4 and by an equivalent weight of at most 65.0 g/mol; with the proviso that when a mixture of alcoholising compounds is used, the average hydroxyl functionality of all alcoholising compounds is at least 4 and the average equivalent weight of all alcoholising compounds is at most 65.0 g/mol.

### FIELD OF THE INVENTION

The present invention relates to an improved method for the recycling of polyurethane (PUR) materials. The present invention further relates to the products obtained by this method and their use.

### BACKGROUND OF THE INVENTION

Polyurethane (PUR) materials are generally produced by the reaction of polyisocyanate compounds, particularly diisocyanates, with isocyanate reactive compounds such as hydroxyl group containing compounds like glycols, polyester polyol and polyether polyol compounds or amine group containing compounds such as aromatic and aliphatic diamines and polyamines. The chemical nature and the relative amounts of the reagents can be selected in agreement with the desired final properties of the PUR materials. This flexibility and wide range of different physical and chemical properties ensure that PUR materials find widespread use. Consequently PUR materials are widely used as flexible, semirigid, rigid and reinforced rigid PUR foams in furniture and bedding, cushioning materials in the automotive industry, as thermal insulation in the construction or the refrigeration industry and also as PUR elastomers in shoe soles, as coatings, adhesives or sealants.

The extensive industrial use of PUR materials and the production thereof is accompanied by a considerable accumulation of waste or scrap of these PUR materials. A large quantity of PUR material scrap is generated during the slabstock manufacturing process. In such operations, from 10% to about 30% of the virgin PUR materials may end up as scrap. This scrap PUR material may be reused for instance by grinding it to PUR powder and adding this powder as a filler in the PUR formulation, or for instance in a rebonding process whereby the waste foam fragments are bonded to each other by means of a binder to produce carpet underlays, pillow fillings or athletic mats.

The major amount of PUR material scrap is however constituted by the end of life (EoL) PUR foam. Yearly more than 30 million mattresses currently reach their end of life, as well as more than 1500 kton of upholstered furniture in the EU. This represents more than 600 ktons of PUR foam. The main waste processing technologies for this EoL PUR foam include incineration and landfill. However such disposal techniques, besides representing an environmental pollution problem, have an economic loss associated with both the land required for landfill and the permanent loss of costly materials as used in the preparation of PUR materials. Therefore, the main interest is to consider the recovery and eventual reuse of such materials.

The known methods for reuse or recycling of PUR materials consist mainly of energy recovery, physical recycling and chemical depolymerisation. In energy recovery methods, the PUR material is used as a fuel and energy is recovered by using the heat and vapour that are produced. However, in this process exhaust fumes are generated which should be strictly controlled to avoid new pollution problems. Physical recycling processes are limited by the thermoset character of PUR materials and often produce end-products of inferior quality. Therefore, it is highly desirable to use chemical depolymerisation to recover the chemical constituents of the PUR material, such as the polyol or polyisocyanate compound, to manufacture new PUR materials.

Chemical depolymerisation of PUR materials is well known in the art and may be achieved, amongst other processes, by hydrolysis, hydroalcoholysis, alcoholysis and aminolysis.

The most commonly used method in chemical depolymerisation of PUR materials is the alcoholysis method, sometimes referred to as glycolysis method, and involves mixing the PUR materials with one or more compounds containing at least two reactive hydroxyl groups, i.e. an alcoholising compound. The mixture is reacted at a high temperature to produce a liquid product comprising a mixture of compounds containing hydroxyl end groups (the recovered polyol), the alcoholising compound(s), amine compounds derived from the polyisocyanate compounds used in the starting PUR material, as well as dicarbamate and amine-carbamate derivatives of these polyisocyanate compounds. The alcoholising methods for PUR materials known in the art are either mono-phase methods or split-phase methods wherein at least two phases are formed, most commonly referred to as the upper phase and bottom or lower phase. Most commonly, the upper phase predominantly comprises the recovered polyol compound which in the best case is similar to the polyol compound which was used to prepare the PUR material. The split-phase alcoholysis method allows to obtain a higher purity recovered polyol compound which is less contaminated than in the mono-phase method. It is beneficial to obtain a recovered polyol compound of which the properties, such as molecular weight and in particular the hydroxyl value, are very similar to the polyol compound which was originally used to prepare the PUR material. When the properties are similar, the recovered polyol compound can be employed to replace up to 100% of the virgin polyol compounds to prepare new PUR materials.

A disadvantage of the split-phase alcoholysis method is that at least one other phase is formed as well, most commonly the bottom phase. To economically optimize the alcoholysis method, ideally this other phase should be further recycled or reused in the alcoholysis method. The bottom phase is predominantly formed by the alcoholising compound and diamine, dicarbamate and amine-carbamate derivatives of the polyisocyanate compounds used to prepare the PUR material. Generally, the amine compounds, whether in the upper or the bottom phase, are unwanted and their content is reduced by means of reacting them with other compounds such as alkylene oxide to produce polyols which can be used for instance to produce rigid foam PUR materials.

GB 1520296 discloses a mono-phase alcoholysis method for decomposing PUR foams comprising heating the PUR foam in the presence of an alcoholate as alcoholising compound and optionally a decomposition accelerator, where the alcoholate is produced by alcoholating a part of the hydroxyl groups of an alcohol, or a part of the hydroxyl groups of an adduct of the alcohol or amine and an alkylene oxide. The alcohol for preparing the alcoholate is selected from monohydric alcohols such as methanol, ethanol, propanol, and the like; dihydric alcohols such as ethylene glycol and propylene glycol; trihydric alcohols such as glycerine and trimethylolpropane; and polyhydric alcohols such as pentaerythritol, diglycerine, sorbitol, α-methylglycoside, sugar, and the like. To produce the alcoholate, the alcohol or the alkylene oxide adduct thereof is alcoholated with an alkali metal hydroxide. The method as described in GB 1520296 is a mono-phase alcoholysis method and, besides generating a lower purity recovered polyol compound, it has the disadvantage of needing an extra method step in which the alcoholate is formed. Furthermore, the use of alkali metal hydroxides to create the alcoholate will inevitably generate alkali metal salt waste which needs to be removed. This adds significant further complexity to the overall method.

WO 95/10562 proposes a split-phase alcoholysis process in which the alcoholising compound is preferably selected from glycerol and an oxyethylene polyol having a molecular weight of 62-500 which may have a hydroxyl functionality of 2-8, and may be selected from ethylene glycol and polyols prepared by reacting ethylene oxide with an initiator having a hydroxyl functionality of 2-8 like ethylene glycol, glycerol, trimethylolpropane, pentaerythritol and sorbitol. The preferred hydroxyl functionality is 2 and the most preferred alcoholising compounds are ethylene glycol or diethylene glycol. However, in order to obtain a high purity recovered polyol compound

WO 95/10562 proposes numerous different further purification steps. The first purification step consists of a batchwise or continuous extraction with an extracting compound which is another polyol compound. In a second purification step, the remaining extracting compound is removed by evaporation, filtration and/or distillation. In the example section, Example 1 of WO 95/10562 discloses a recovered polyol compound having an OH value of 33 mg KOH/g and containing only 0.4% by weight of the alcoholising compound. However, these results are only obtained after intensive purification steps including 7 extractions, a 3 h distillation step and a filtration step. An obvious drawback of the method of WO 95/10562 is that it requires a lot of extra purification steps to obtain a high purity recovered polyol compound. Furthermore, although it is not mentioned, it is evident that with every extra purification step the product yield will decrease. In addition, these purification steps are also a significant consumer of heat at a relatively high temperature level. Because of the complex equipment and the energy consumption, this additional step is expensive. thereby decreasing the economic viability of the method.

In WO 97/27243 a split-phase alcoholysis process is disclosed in which the alcoholising compound is similar to the one described in WO 95/10562 and wherein water is added to the mixture of PUR material and alcoholising compound before the mixture is allowed to phase separate into an upper and bottom phase. WO 97/27243 mainly focusses on the further purification and the reuse of said bottom phase. The bottom phase may first be subjected to purification steps such as evaporation or distillation in order to remove the alcoholising compound. WO 97/27243 then proposes to hydrolyse the bottom phase before alkoxylation. Subsequently, the alkoxylated products are then used in the preparation of rigid PUR foams. However, the possibilities for reusing the alkoxylated product are limited.

Therefore, there remains a need for an improved split-phase method for alcoholising PUR materials which is economically advantageous to operate and which yields at least two phases, one phase comprising a high quality recovered polyol compound in such a way that the recovered polyol compound may replace the originally used polyol compound in a PUR material formulation up to 100% without the need of extensive purification and another phase, mainly comprising the alcoholising compound and by-products such as diamine compounds allowed to be used in other applications, optionally after further purification and/or further chemical treatment or which may be re-used in the alcoholysis method.

### SUMMARY OF THE INVENTION

The inventors have now surprisingly found that it is possible to provide an improved split-phase alcoholysis method fulfilling the above-mentioned needs.

Thus, the object of the present invention is to provide a method for alcoholising polyurethane (PUR) materials made from at least one polyol compound having a hydroxyl value X and at least one polyisocyanate compound; wherein the method comprises the following steps:
contacting the polyurethane material with at least one alcoholising compound, thereby forming a reaction mixture (M₀) and allowing the polyurethane material and the alcoholising compound to react in said reaction mixture (M₀), thereby forming a mixture (M);
allowing the mixture (M) to separate into at least two immiscible phases;
   wherein at least one phase is characterized by a hydroxyl value Y wherein Y≤3.5*X; wherein at least one alcoholising compound is characterized by a hydroxyl functionality of at least 4 and by an equivalent weight of at most 65.0 g/mol; and with the proviso that when a mixture of alcoholising compounds is used, the average hydroxyl functionality of all alcoholising compounds is at least 4 and the average equivalent weight of all alcoholising compounds is at most 65.0 g/mol.

It is a further object of the present invention to provide a recovered polyol compound obtained according to the method as detailed above.

It is also a further object of the present invention to provide PUR materials produced from said recovered polyol compound.

### DETAILED DESCRIPTION

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to composition consisting only of components A and B. It means that with respect to the present invention, the only relevant components of the composition are A and B. Accordingly, the terms “comprising” and “including” encompass the more restrictive terms “consisting essentially of” and “consisting of”.

Within the context of the present invention, the expression “at least one alcoholising compound” is intended to denote one or more than one alcoholising compound. Mixtures of alcoholising compounds can also be used for the purpose of the invention. In the remainder of the text, the expression “alcoholising compound” is understood, for the purposes of the present invention, both in the plural and the singular form.

In the context of the present invention, the prefix “poly” is used for meaning “more than one”, which when limited to integers is the same as “2 or more” or “at least 2”. The term “polyol” therefore stands for a compound having at least 2 alcohol or hydroxyl (—OH) functional groups. The term “polyisocyanate” thus stands for a compound having at least 2 isocyanate (NCO or more correctly —N═C═O) functional groups.

Thus, in the method of the present invention use is made of at least one alcoholising compound having a hydroxyl functionality of at least 4 and an equivalent weight of at most 65.0 g/mol.

Within the context of the present invention, the term “alcoholising compound” is intended to denote those compounds which are able to alcoholise PUR materials. Preferably those alcoholising compounds are immiscible with the recovered polyol compound obtained in the alcoholysis method. The term “immiscible” is used in its conventional sense to refer to two compounds that are less than completely miscible, in that mixing two such compounds results in a mixture containing more than one phase. It is preferred that at most 30%, preferably at most 20%, more preferably at most 10%, even more preferably at most 5% by weight of alcoholising compound can be dissolved in the recovered polyol compound at room temperature. Preferably, the alcoholising compounds have a larger density than the density of the recovered polyol compound.

Within the context of the present invention, the term “hydroxyl functionality” of an alcoholising compound refers to the number of hydroxyl (—OH) functional groups per molecule, on average.

Preferably, the hydroxyl functionality of the at least one alcoholising compound as used in the method according to the present invention is at least 4 and preferably the hydroxyl functionality of the at least one alcoholising compound is at most 8, more preferably at most 7, even more preferably at most 6.

Within the context of the present invention, the term “equivalent weight” of an alcoholising compound refers to the average weight of the compound or mixture per reactive hydroxyl (OH) group or, for a single alcoholising compound, as the molecular weight of the alcoholising compound divided by its hydroxyl functionality.

Preferably, the equivalent weight of the at least one alcoholising compound as used in the method according to the present invention is at most 60.0 g/mol, more preferably at most 55.0 g/mol, more preferably at most 50.0 g/mol, even more preferably at most 48.0 g/mol, yet even more preferably at most 46.0 g/mol and most preferably at most 44.0 g/mol.

It is understood that the lower value of the equivalent weight of the at least one alcoholising compound as used in the method according to the present invention is not limited but advantageously is at least 28.0 g/mol.

If desired, other alcoholising compounds not fulfilling the requirement of having a hydroxyl functionality of at least 4 and an equivalent weight of at most 65.0 g/mol, may be added. However, it is necessary that, when more than one alcoholising compound is present, then the average hydroxyl functionality of all alcoholising compounds is at least 4 and the average equivalent weight of all alcoholising compounds is at most 65 g/mol. The average hydroxyl functionality can be calculated by taking into account the relative amounts (in weight) of each alcoholising compound and its respective hydroxyl functionality. The average equivalent weight can be calculated by taking into account the relative amounts (in weight) of each alcoholising compound and its respective equivalent weight.

In one embodiment of the method according to the present invention, at least one of the alcoholising compounds, as detailed above, has a hydroxyl functionality of at least 4 and an equivalent weight of at most 65.0 g/mol and the average hydroxyl functionality of all alcoholising compounds is at least 4 and the average equivalent weight of all alcoholising compounds is at most 65.0 g/mol.

In a preferred embodiment of the method according to the present invention, each of the alcoholising compounds, as detailed above, has a hydroxyl functionality of at least 4 and an equivalent weight of at most 65.0 g/mol.

According to a preferred embodiment of the method of the present invention the at least one alcoholising compound is selected from the group consisting of diglycerol, triglycerol, tetraglycerol pentaerythritol, dipentaerythritol, di(trimethylolpropane), di(trimethylolethane), erythritol, xylitol, sorbitol, mannitol, galactitol, arabitol, ribitol, fucitol, iditol and or mixtures of two or more thereof. Preferably, the at least one alcoholising compound is selected from diglycerol, pentaerythritol, sorbitol, xylitol, or mixtures of two or more thereof. More preferably the at least one alcoholising compound is selected from diglycerol, pentaerythritol or mixtures thereof. Most preferably the at least one alcoholising compound is diglycerol.

The polyurethane (PUR) material that is to be alcoholised by the method according to the present invention is made by reacting at least one polyisocyanate compound with at least one polyol compound having a hydroxyl value X, optionally a blowing agent and optionally a chain extender or cross-linker and additives conventionally used in preparing PUR materials.

In a preferred embodiment of the method according to the present invention, the at least one polyol compound is characterized by a hydroxyl value X wherein X is at least 15 mg KOH/g, preferably equal to or at least 20 mg KOH/g, even more preferably at least 25 mg KOH/g.

It is further understood that the hydroxyl value X of the at least one polyol compound is advantageously equal to or lower than 200 mg KOH/g, preferably equal to or lower than 150 mg KOH/g, more preferably equal to or lower than 100 mg KOH/g, even more preferably equal to or lower than 75 mg KOH/g, most preferably equal to or lower than 50 mg KOH/g.

Within the context of the present invention, the term “hydroxyl value X”, “OH number X” and similar expressions are intended to denote the hydroxyl (OH) content as analysed according to standard titration methods such as ASTM 4274, ISO 14900 or ASTM E1899, and is expressed in mg KOH/g of sample, unless mentioned otherwise.

It is understood that mixtures of polyol compounds may be used. In this case, the hydroxyl value X of the polyol compound is the average hydroxyl value of the mixture of polyol compounds. It is further understood that when commercially available polyol compound mixtures are used, the hydroxyl value may be influenced by other ingredients such as crosslinkers present in said mixtures. However, this contribution is assured to be negligible.

In a preferred embodiment of the method according to the present invention, the PUR material is a PUR foam and more preferably a flexible PUR foam.

The expression “PUR foam” as used herein generally refers to cellular products as obtained by reacting polyisocyanate compounds with polyol compounds, using foaming or blowing agents, and in particular includes cellular products obtained with water as reactive foaming or blowing agent.

Such PUR foams, ingredients used for preparing the PUR foams and processes for preparing such PUR foams have been described extensively in the art. PUR foams may be produced by reacting polyisocyanate compounds with polyol compounds.

Polyisocyanate compounds suitable for producing such PUR foams may be selected from aliphatic, cycloaliphatic and araliphatic polyisocyanates, especially diisocyanates such as hexamethylene diisocyanate, isophorone diisocyanate, cyclohexane-1,4-diisocyanate, 4,4′-dicyclohexylmethane diisocyanate and m- and p-tetramethylxylylene diisocyanate, and in particular aromatic polyisocyanates like toluene diisocyanates (TDI), phenylene diisocyanates and methylene diphenyl isocyanates (MDI) having an isocyanate functionality of at least two. The toluene diisocyanates (TDI) may be selected from pure 2,4-TDI and isomeric mixtures of 2,4-TDI and 2,6-TDI. The methylene diphenyl isocyanates (MDI) may be selected from pure 4,4′-MDI, isomeric mixtures of 4,4′-MDI and 2,4′-MDI and less than 10% by weight of 2,2′-MDI, crude and polymeric MDI having isocyanate functionalities above 2.

Modified polyisocyanate compounds are also useful. Such modified polyisocyanate compounds are generally prepared through the reaction of a polyisocyanate compound such as TDI or MDI, with a low molecular weight diol or amine. Modified polyisocyanate compounds can also be prepared through the reaction of the polyisocyanate compounds with themselves, producing polyisocyanate compounds containing allophanate, uretonimine, carbodiimide, urea, biuret or isocyanurate linkages.

Mixtures of two or more polyisocyanate compounds as mentioned above may be used if desired.

Most preferred polyisocyanate compounds suitable for producing such PUR foams may be selected from toluene diisocyanates (TDI) and methylene diphenyl isocyanates (MDI).

Suitable polyol compounds for preparing such PUR foams may be selected from polyester, polyesteramide, polythioether, polycarbonate, polyacetal, polyolefin and polysiloxane polyols, polyols derived from vegetable oils, other biobased polyols and mixtures of two or more thereof. Preferably, the polyol compound is a polyether polyol.

Non-limiting examples of polyether polyols which may be used for preparing such PUR foams include these polyether polyols which are prepared by allowing one or more alkylene oxides or substituted alkylene oxides to react with one or more active hydrogen containing initiators. Suitable oxides are for example ethylene oxide, propylene oxide, tetrahydrofuran, butylene oxides, styrene oxide, epichlorhydrin and epibromhydrin. Mixtures of two or more oxides may be used. Suitable initiators are for example water, ethylene glycol, propylene glycol, butanediol, hexanediol, glycerol, trimethylol propane, pentaerythritol, sorbitol, sucrose, hexanetriol, hydroquinone, resorcinol, catechol, bisphenols, novolac resins and phosphoric acid. Further suitable initiators are for example ammonia, ethylenediamine, diaminopropanes, diaminobutanes, diaminopentanes, diaminohexanes, ethanolamine, aminoethylethanolamine, aniline, 2,4-toluenediamine, 2,6-toluenediamine, 2,4′-diamino-diphenylmethane, 4,4′-diaminodiphenylmethane, 1,3-phenylenediamine, 1,4-phenylenediamine, naphthalene-1,5-diamine, 4,4′-di(methylamino)-diphenylmethane, 1-methyl-2-methylamino-4-aminobenzene, 1,3-diethyl-2,4-diaminobenzene, 2,4-diamonomesitylene, 1-methyl-3,5-diethyl-2,4-diaminobenzene, 1-methyl-3,5diethyl-2,6-diaminobenzene, 1,3,5-triethyl-1,2,6-diaminobenzene and 3,5,3′,5′-tetraethyl-4,4′-diaminodiphenylmethane. Mixtures of two or more initiators may be used.

Non-limiting examples of polyester polyols which may be used for preparing such PUR foams include hydroxyl-terminated reaction products of polyhydric alcohols such as ethylene glycol, propylene glycol, diethylene glycol, 1,4-butanediol, neopentyl glycol, 1,6-hexanediol, cyclohexane dimethanol, glycerol, trimethylolpropane, pentaerythritol or polyether polyols or mixtures of such polyhydric alcohols, and polycarboxylic acids, especially dicarboxylic acids or their ester-forming derivatives, for example succinic, glutaric and adipic acids or their dimethyl esters, sebacic acid, phthalic anhydride, tetrachlorophthalic anhydride or dimethyl terephthalate or mixtures thereof. Polyesters obtained by the polymerisation of lactones, for example caprolactone, in conjunction with a polyol, or of hydroxy carboxylic acids such as hydroxy caproic acid, may also be used.

Non-limiting examples of polyols derived from vegetable oils which may be used for preparing such PUR foams include polyols derived from castor oil, soy bean oil, peanut oil, canola oil, and mixtures of two or more thereof.

Suitable polyol compounds for preparing such PUR foams may also include so-called polymer polyols. These are polyol compounds wherein one or more solid polymers is stably dispersed. These polyol compounds are numerously described in the art, such as in U.S. Pat. Nos. 3,383,351 and 3,304,273. Such polymer polyols may be produced by polymerizing one or more ethylenically unsaturated monomers dissolved or dispersed in a polyol compound in the presence of a free radical catalyst to form a stable dispersion of polymer particles in the polyol compound. A wide variety of monomers may be utilized in the preparation of the polymer polyols. Numerous ethylenically unsaturated monomers are disclosed in the prior art and polyurea and polyurethane suspension polymers can also been utilized. Exemplary monomers include styrene and its derivatives such as para-methylstyrene, acrylates, methacrylates such as methyl methacrylate, acrylonitrile and other nitrile derivatives such as methacrylonitrile, and the like. Vinylidene chloride may also be employed. The preferred monomer mixtures used to make the polymer polyols are mixtures of acrylonitrile and styrene (SAN polyols) or acrylonitrile, styrene and vinylidene chloride. These polymer polyol compositions have the valuable property of imparting to PUR foams produced therefrom higher load-bearing properties than are provided by the corresponding unmodified polyol compounds. Suitable polyol compounds for preparing such PUR foams may also include the polyols compounds as taught in U.S. Pat. Nos. 3,325,421 and 4,374,209.

It is understood that the PUR foams as used in the method according to the present invention may further comprise other common additional ingredients conventional to PUR foam formulations. Such other common additional ingredients include, but are not limited to, chain-extending and cross-linking agents, blowing agents, urea and urethane formation enhancing catalysts, surfactants, stabilisers, flame retardants, organic and inorganic fillers, pigments, agents for suppressing the so-called boiling-foam effect, internal mould release agents for moulding applications and anti-oxidants.

Non limiting examples of chain-extending and cross-linking agents amines and polyols containing 2-8 and preferably 2-4 amine and/or hydroxy groups like ethanolamine, diethanolamine, triethanolamine, ethylene glycol, diethylene glycol, triethylene glycol, propylene glycol, dipropylene glycol, butanediol, glycerol, trimethylolpropane, pentaerithrithol, sorbitol, sucrose, polyethylene glycol having an equivalent weight of less than 500, toluene diamine, diethyl toluene diamine, cyclohexane diamine, phenyl diamine, diphenylmethane diamine, an alkylated diphenyl ethane diamine and ethylene diamine.

Advantageously, the amount of chain-extending and cross-linking agents is, when present, up to 25 and preferably up to 10 parts by weight per 100 parts by weight of the polyol compound.

Non limiting examples of blowing agents which optionally may be used in preparing such PUR foams may be selected from physical blowing agents like chlorofluorocarbons, hydrogen chlorofluorocarbons, hydrogen fluorocarbons and preferably from chemical blowing agents, especially those which lead to CO₂ liberation when reacted with the polyisocyanate under foam forming conditions such as water, formic acid and derivatives thereof. Most preferably water is used as the sole blowing agent.

Advantageously, the amount of blowing agent ranges from 2-20 preferably from 3-15 parts by weight per 100 parts by weight of polyol compound.

The optional common additional ingredients which may be used in preparing such PUR foams may be premixed with the polyol compound before this is reacted with the polyisocyanate compound in order to prepare the PUR foams.

The PUR foams may be made according to the one-shot process, the semi- or quasi prepolymer process or the prepolymer process.

The PUR foams may be slab-stock or moulded PUR foams. The PUR foams in general have a density of 15-80 kg/m³ and may have been used as cushioning material in furniture, car-seats and mattresses for instance.

Although in principle any PUR foam may be used in the method according to the present invention, TDI-based, polyether polyol-based, fully water blown flexible PUR foams are particularly preferred in view of the very good results obtained, as will be described hereinafter.

It is further understood that all definitions and preferences, as described above, equally apply for all further embodiments, as described below.

As said, in the method of the present invention, the PUR material, as detailed above, is contacted with at least one alcoholising compound, as detailed above, thereby forming a reaction mixture (M₀) and the PUR material and the alcoholising compound are allowed to react in said reaction mixture (M₀) so as to obtain a mixture (M).

In a preferred embodiment of the method of the present invention, the amount of the at least one alcoholising compound, relative to 1 part by weight (pbw) of PUR material, is advantageously equal to or less than 10 pbw, preferably equal to or less than 5 pbw, more preferably equal to or less than 2.5 pbw, even more preferably equal to or less than 1.5 pbw, yet even more preferably equal to or less than 1.0 pbw and most preferably equal to or less than 0.5 pbw.

It is further understood that the amount of the at least one alcoholising compound, relative to 1 pbw of PUR material, is advantageously equal to or greater than 0.1 pbw, preferably equal to or greater than 0.2 pbw, more preferably equal to or greater than 0.3 pbw, even more preferably equal to or greater than 0.4 pbw.

According to certain embodiments of the method according to the present invention, the reaction mixture (M₀) further comprises water.

When water is present in the reaction mixture (M₀), the amount of water is advantageously at least 0.01 pbw, relative to 1 pbw of PUR material, preferably 0.025 pbw and more preferably 0.05 pbw. It is further understood that the upper limit of the water is not particularly limited but the amount of water present in the reaction mixture (M₀) should not adversely affect the phase separation of mixture (M).

In a preferred embodiment of the method according to the present invention, the reaction mixture (M₀) further comprises at least one alcoholysis accelerator which accelerates the alcoholysis of the PUR material in the at least one alcoholising compound.

The term “acceleration of alcoholysis” designates the effect that carbamates in the PUR material are converted into compounds comprising a primary and/or secondary amine, such as diamine compounds like toluene diamine or methylene diphenyl diamine compounds; carbamate-amine compounds like toluene carbamate-amine or methylene diphenyl carbamate-amine compounds; and dicarbamate compounds like toluene dicarbamate or methylene diphenyl dicarbamate compounds; and the respective polyol compound of which the PUR material was made. A part of the alcoholysis accelerator may react with other compounds or by-products, such as isocyanate compounds, present in the mixture (M₀).

Suitable alcoholysis accelerators for use in the method of the present invention may include, but are not limited to, heterocyclic amines, straight or branched chain aliphatic amines, cycloalkylamines, aromatic amines or cyclic amides.

Non-limiting examples of heterocyclic amines include piperazine, aminoethylpiperazine, piperidine, morpholine, N-ethylmorpholine, hexamethylenetetraamine, triethylenediamine, 1,8-diazabiclo(5,4,0)-undecene, pyridine, picoline, imidazole, pyrazol, triazole, tetrazole, and the like.

Non-limiting examples of straight chain aliphatic amines include ethylenediamine, diethylenetriamine, triethylenetetraamine, tetraethylenepentaamine, monopropylamine, dipropylamine, monobutylamine, dibutylamine, octylamine, laurylamine, triethylamine, tetramethylenediamine, hexamethylenediamine, monoethanolamine, diethanolamine, triethanolamine, isopropylamine, isobutylamine, diisobutylamine, and the like. Of these compounds, commercially preferred amines are ethylenediamine, diethylenetriamine, monoethanolamine, and the like.

Non-limiting examples of cycloalkylamines include cyclohexylamine, dicyclohexylamine, cyclopentylamine, bisaminomethyl cyclohexane, and the like.

Non-limiting examples of aromatic amines include aniline, phenylenediamine, dimethylaniline, monomethylaniline, toluidine, anisidine, diphenylamine, benzidine, phenetidine, tolidine, benzylamine, xylylenediamine, tolylenediamine, diphenylmethane-4,4′-diamine, and the like.

Non-limiting examples of cyclic amides include α-lactam, β-lactam, pyrrolidone, piperidone, valerolactam and caprolactam.

Preferably, the at least one alcoholysis accelerator for use in the method of the present invention is selected from cyclic amides such as 2-pyrrolidone, valerolactam, caprolactam and mixtures of two or more thereof. More preferably, the at least one alcoholysis accelerator for use in the method of the present invention is 2-pyrrolidone.

Advantageously, the amount of the alcoholysis accelerators, when present, is from 0.01 to 1 parts by weight, more preferably from 0.05 to 0.5 parts by weight, most preferably from 0.08 to 0.2 parts by weight, relative to 1 part by weight of the PUR material.

According to certain embodiments of the method according to the present invention, the reaction mixture (M₀) further comprises at least one catalyst to enhance the alcoholysis of the PUR material.

Non-limiting examples of catalysts suitable for use in the method of the present invention may include (organo)tin and bismuth catalysts such as dimethyltin dichloride, butyltin trichloride, dimethyltin dilaurate, dimethyltin dioleate, dimethyltin mercaptide, dibutyltin diacetate, dimethyltin dineodecanoate, bismuth(III) neodecanoate, bismuth 2-ethylhexanoate and triphenylbismuth, alkali metals and alkali metal hydroxides such as potassium hydroxide and sodium hydroxide, titanium(IV) alkoxides such as titanium(IV) propoxide, titanium(IV) butoxide and titanium(IV) tert-butoxide, alkoxide complexes of lithium and potassium such as lithium t-butoxide and potassium t-butoxide, tetrabutyltitanate, potassium acetate, potassium 2-ethylhexanoate, calcium 2-ethylhexanoate, bismuth(III) trifluoromethanesulfonate, iron(III) acetylacetonate, aluminium isopropoxide, dimethylimidazole, potassium adipate and in general urethane-reaction promoting catalysts. Preferably the at least one catalyst is selected from lithium t-butoxide, potassium t-butoxide, potassium hydroxide, aluminium isopropoxide, butyltin trichloride, dimethyltin dilaurate, dibutyltin diacetate, dimethyltin dineodecanoate, bismuth(III) neodecanoate or bismuth(III) 2-ethylhexanoate. More preferably, the at least one catalyst is selected from dibutyltin diacetate, dimethyltin dineodecanoate or bismuth(III) neodecanoate.

Advantageously, the amount of the at least one catalyst, when present, is from 0.001 to 0.3 pbw, more preferably from 0.005 to 0.1 pbw, most preferably from 0.008 to 0.05 pbw, relative to 1 pbw of the PUR material.

According to certain embodiments of the method according to the present invention, the reaction mixture (M₀) further comprises dissolution accelerators which accelerate the dissolution of the PUR material in the one or more alcoholising compounds.

The term “acceleration of dissolution” designates a permeating effect which so that the alcoholising compound penetrates into the mass of the PUR material to increase or enlarge the contact area between the PUR material and the alcoholising compound whereby the PUR material easily dissolves.

It is thus understood that some alcoholysis accelerators will function as a dissolution accelerator as well.

Non-limiting examples of dissolution accelerators suitable for use in the method of the present invention may include polyether polyols and other polyols that are suitable to be used with the polyol compounds used in the production of new PUR materials.

PUR material may be contacted with the at least one alcoholising compound in the form in which it is received but preferably the size of the PUR material is reduced, if necessary, in a way suitable for reducing the size and/or for increasing the density of PUR material, like by cutting, milling, pelletizing, grinding, comminution, densification and pressing and any combinations thereof. Although the success of the method of the present invention does not greatly depend on the size of the PUR material it is for efficiency and handling reasons preferred to have PUR material pieces having an average diameter between 0.1 mm and 10 cm, preferably between 0.1 mm and 5 cm and more preferably between 0.1 mm and 3 cm.

Preferably, the PUR material and the at least one alcoholising compound are contacted by adding them in a container suitable to conduct an alcoholysis reaction and by normal mixing, thereby forming a mixture (M₀).

Generally, it is understood that the order of addition of each compound of the mixture (M₀), such as the PUR material and the at least one alcoholising compound, is not particularly limited. Preferably, a mixture is prepared containing the at least one alcoholising compound, optionally the catalyst and optionally the alcoholysis accelerator. The PUR material is added to this mixture, either or not in intervals. The alcoholysis, i.e. a depolymerisation reaction, starts after the dissolution of the PUR material is complete.

The PUR material and the at least one alcoholising compound are allowed to react in an alcoholysis reaction and preferably, the alcoholysis reaction conditions are chosen in such a way that equilibrium is reached in a reasonable period of time. It is understood that the reaction conditions for the alcoholysis such as temperature, reaction time (including dissolution as well as alcoholysis) and pressure depend on the alcoholising compound that is used and on the scale of the reaction. A person skilled in the art is able to determine suitable reaction conditions.

Generally, the mixture (M₀) is subjected to a pressure ranging from ambient pressure to 10 bar, preferably from ambient pressure to 5 bar and most preferably to ambient pressure.

Preferably, the temperature of the mixture (M₀) is at least 170° C., more preferably at least 180° C., even more preferably at least 190° C., and preferably at most 240° C., more preferably at most 220° C. and even more preferably at most 210° C.

It is understood that when the temperature of the mixture (M₀) in the method according to the present invention is a temperature at which the selected alcoholising compound is solid, a small amount of solvent may be required to induce a freezing point depression in order to make the alcoholising compound liquid. Suitable solvents include 2-pyrrolidone, glycerol, diglycerol or mixtures thereof, in an amount from 0.05 to 0.15 pbw, relative to 1 pbw of the PUR material.

Preferably, the PUR material and the at least one alcoholising compound are allowed to react during a reaction time of at least 0.5 hours, or at least 1 hour, or at least 1.5 hours, or at least 2 hours.

It is further understood that the reaction time is not particularly limited, however, advantageously the reaction time is at most 48 hours, or at most 24 hours or at most 15 hours, or at most 10 hours, or at most 6 hours.

In a preferred embodiment of the method according to the present invention, the PUR material and the at least one alcoholising compound are allowed to react while stirring and under a N₂ blanket.

As said, in the method of the present invention, the formed mixture (M) is allowed to separate into at least two immiscible phases.

As said above, the term “immiscible” is used in its conventional sense and it is preferred that at most 30%, preferably at most 20%, more preferably at most 10%, even more preferably at most 5% by weight of one phase of mixture (M), for example the upper phase, can be dissolved in another phase of mixture (M), for example the lower phase, at room temperature.

The mixture (M) is left to stand for a period of time sufficient to allow the mixture (M) to separate into at least two immiscible phases. Generally a period ranging from 1 minute to 24 hours, or from 1 minute to 1 hour will be sufficient. Advantageously, this period is at least 15 minutes, or at least 30 minutes, or at least 1 hour, or at least 2 hours or at least 4 hours, and preferably at most 24 hours, or at most 12 hours, or at most 6 hours, or at most 4 hours, or at most 3 hours.

After the optional stirring of the mixture (M) has been discontinued, the temperature may be maintained while the phases are allowed to separate and when the phases are collected. Preferably, the temperature of the reaction mixture (M) is reduced by cooling or by no longer supplying heat after the optional stirring has been discontinued or after phase separation but before collecting the phases.

Optionally, the mixture (M) may be centrifuged to enhance the separation of the phases.

In one embodiment of the method according to the present invention, the mixture (M) is allowed to separate into two immiscible phases, phase (A) and phase (B) herein after, wherein phase (A) is characterized by a hydroxyl value Y wherein Y≤3.5*X.

Phase (A) and phase (B) are then collected separately in a conventional way, for example by decanting one of the phases or by removing one of the phases via an outlet in the bottom of the container. Sometimes an interface may be present after phase separation between two phases, which interface may be collected separately or together with either of the two phases. Occasionally, when the PUR material formulation included mineral loads, for example calcium carbonate, a solid fraction comprising these mineral loads is formed as well.

The method according to the present invention may be conducted batchwise or continuously.

Phase (A), most commonly the upper phase, predominantly comprises a recovered polyol compound from which the PUR material was made while phase (B), most commonly the lower phase, predominantly comprises other chemicals obtained together with the at least one alcoholising compound, as detailed above.

The inventors have surprisingly found that by using the at least one alcoholising compound, as detailed above, compared to an alcoholising method using an alcoholising compound not fulfilling the above mentioned requirements, the amount of the at least one alcoholising compound, as detailed above, remaining in phase (A) is considerably reduced even without an extraction or distillation step of phase (A).

In a preferred embodiment of the method according to the present invention, the amount of the at least one alcoholising compound, as detailed above, remaining in phase (A), relative to the total weight of phase (A), is equal to or less than 3.0 wt %, preferably equal to or less than 2.5 wt %, more preferably equal to or less than 2.0 wt %, even more preferably equal to or less than 1.6 wt %, yet even more preferably equal to or less than 1.4 wt %, even more preferably equal to or less than 1.2 wt %, most preferably equal to or less than 1.0 wt %.

In a preferred embodiment of the method according to the present invention, the amount of the recovered polyol compound in phase (A), relative to the total weight of phase (A), is equal to or more than 86.0 wt %, preferably equal to or more than 92.0 wt %, more preferably equal to or more than 93.0 wt %, even more preferably equal to or more than 93.5 wt %, yet even more preferably equal to or more than 94.0 wt %, even more preferably equal to or more than 94.5 wt %, most preferably equal to or more than 95.0 wt %.

In a preferred embodiment of the method according to the present invention, the yield of the recovered polyol compound, calculated as the weight of the recovered polyol compound relative to the total weight of the at least one polyol compound in the PUR material, is equal to or more than 50.0%, preferably equal to or more than 60.0%, more preferably equal to or more than 70.0%, even more preferably equal to or more than 80.0%, most preferably equal to or more than 95.0%.

The yield of the recovered polyol compound is calculated by dividing the weight of the recovered polyol compound by the total weight of the at least one polyol compound which was used to manufacture the PUR material (weight of the PUR material multiplied by the polyol compound content).

The inventors have further found that by using the at least one alcoholising compound, as detailed above, the hydroxyl value of the phase (A) is very similar to the hydroxyl value of the polyol compound or the average hydroxyl value of the mixture of polyol compounds which was used to prepare the PUR material. Because of this similarity, phase (A) can be used in the preparation of new PUR materials, in particular new flexible PUR foams. Up to 100% of phase (A) may be used which means that no polyol compound other than phase (A) is required for preparing new PUR materials.

In one embodiment of the method according to the present invention, phase (A) is characterized by a hydroxyl value Y wherein Y≤3.5*X, preferably Y≤3*X, more preferably Y≤2.75*X, even more preferably Y≤2.5*X, yet even more preferably Y≤2.25*X, most preferably Y≤2*X.

In one embodiment of the method according to the present invention, phase (A) is characterized by a hydroxyl value Y equal to or less than 200 mg KOH/g, preferably equal to or less than 175 mg KOH/g, more preferably equal to or less than 150 mg KOH/g, even more preferably equal to or less than 125 mg KOH/g, yet even more preferably equal to or less than 100 mg KOH/g, even more preferably equal to or less than 80 mg KOH/g, most preferably equal to or less than 65 mg KOH/g.

The hydroxyl value Y may be determined by using titration measurements according to the standard method ASTM E1899, as mentioned above. However, contaminating compounds in phase (A) such as amine compounds and optional alcoholysis accelerators may contribute to the hydroxyl value. Therefore, the hydroxyl value Y of phase (A) may also be approached theoretically by multiplying the weight fractions of the compounds with their respective theoretical hydroxyl values. The weight fractions of the compounds were determined via integration of the NMR signal peaks from characteristic protons. The different compounds contributing to the OH-value are the recovered polyol compound, the alcoholising compound, carbamate-amine compounds, diamine compounds and optional alcoholysis accelerators. The procedure is explained in detail in the experimental section.

Furthermore, a corrected hydroxyl value Y_{c} may be calculated by subtracting the contribution of the carbamate-amine and diamine compounds and of the optional alcoholysis accelerators from the hydroxyl value Y. With this approach, only the contribution of the recovered polyol compound and the alcoholising compound remaining in the phase (A) is taken into account.

In one embodiment of the method according to the present invention, phase (A) is characterized by a corrected hydroxyl value Y_{c} wherein Y_{c}≤2*X, preferably Y_{c}≤1.75*X, more preferably Y_{c}≤1.5*X, even more preferably Y_{c}≤1.25*X.

The alcoholysis reaction of the PUR material and the at least one alcoholising compound yields by-products comprising a primary and/or secondary amine, such as diamine compounds like toluene diamine or methylene diphenyl diamine compounds; carbamate-amine compounds like toluene carbamate-amine or methylene diphenyl carbamate-amine compounds; and dicarbamate compounds like toluene dicarbamate or methylene diphenyl dicarbamate compounds. Although these by-products are predominantly present in phase (B), some of these by-products may be present in phase (A). However, the inventors have found that these by-products may be easily removed.

If desired, phase (A) may be further subjected to a purification step to reduce the amount of by-products.

Suitable purification techniques for phase (A) are well known in the art and include, but are not limited to, evaporation, filtration, distillation, extraction, (acid) washing, ion exchange treatments and combinations of two or more thereof.

The presence of by-products, in particular the level of aromatic amines like toluene diamine and methylene diphenyl diamine compounds and higher functional oligomers thereof, in the recovered polyol compound is generally undesirable. In particular these diamine compounds are suspected or regulated carcinogenic agents and therefore generally represent an undesirable hazard. Furthermore, the diamine and carbamate-amine compounds could have an adverse effect when the recovered polyol compound is used to form new PUR materials, they react with isocyanates to yield polyureas which may influence the physical properties and they also greatly influence the PUR formation reaction thereby reducing its controllability.

When phase (A) is further subjected to an extraction process, comprising bringing the phase (A) into contact with an extracting compound, mixing the extracting compound and the phase (A), thereby forming an extraction mixture and allowing the extraction mixture to separate into a phase (A1) and a phase (E), at least one extraction compound may be used which is the same as the at least one alcoholising compounds used to form phase (A) or different, preferably the same.

Phase (A1) comprises a recovered polyol compound from which the PUR material was made while phase (E) comprises the extracting compound and some of the contaminants which were present in phase (A).

The extraction process is carried out as a conventional extraction process. It may be carried out batchwise or continuously. If the process is carried out batchwise this may be done once or preferably at least two and more preferably 2-15 times. The extraction process may be conducted at room temperature or at elevated temperature provided the temperature applied is lower than the boiling point of the extracting compound under the conditions applied. In general the temperature may range from ambient temperature to 240° C. but preferably from 150-240° C. and most preferably 180-220° C. at ambient pressure to 10 bar, preferably ambient pressure to 5 bar, most preferably at ambient pressure. Once the phase (A) and the extracting compound have been combined they are mixed. The amount of extracting compound used may vary between wide ranges. Preferably the weight ratio of extracting compound and phase (A) is at least 0.1:1 and most preferably 0.25-10:1. The mixing preferably is continued for a period of time from 1 minute to 8 hours, more preferably from 5 minutes to 3 hours preferably under a N₂ blanket. If desired, the extraction may be conducted in the presence of a catalytic amount of a catalyst like LiOH, KOH or NaOH.

After the mixing is discontinued the extraction mixture is left in order to allow the extraction mixture to separate in two phases, phase (A1) and phase (E) then the phases are collected. Phase separation and the collection of the phases is conducted essentially in the same way as described above for mixture (M). The extraction process may be integrated with the alcoholysis in a batchwise way or in a continuous process.

In another embodiment of the method according to the present invention, phase (A) is further subjected to an ion-exchange treatment thereby forming a phase (A2).

The inventors have now found that by using the at least one alcoholising compound, as detailed above, the level of by-products such as amine compounds in phase (A) is generally low and, when necessary, can easily be further reduced by ion exchange treatments in a very efficient way. Furthermore, the by-products, and especially the diamine compounds, which are removed from phase (A) in this way, may be recovered and converted into their respective isocyanate compounds, for example by phosgenation, and reused in the production of new PUR materials.

Ion exchange treatments are well-known in the art and have been extensively described.

The ion exchange treatment may be carried out by a strong cation exchanger, such as Dowex 50WX2, in the proton form with a dry capacity of 3 meq/ml. Preferably, the ion exchange is performed in a batch setup wherein the phase (A) is dissolved in a solvent such as methanol at room temperature.

In one embodiment of the method according to the present invention, phase (B) is further subjected to a hydrolysis step, thereby forming a phase (B1).

Phase (B) predominantly comprises the at least one alcoholising compound and other by-products such as dicarbamate, carbamate-amine and diamine compounds reflecting the original polyisocyanate compound used in the preparation of the PUR materials. As explained above, these by-products and especially diamine compounds are often unwanted. However, the inventors have found that by using the at least one alcoholising compound, as detailed above, dicarbamate and carbamate-amine compounds may be partially or fully converted to diamine compounds by hydrolysis of phase (B). After purification, these diamine compounds may be converted, for example by phosgenation, to their respective isocyanate compounds which can be reused for producing new PUR materials. The inventors have found that the hydrolysability of the dicarbamate and carbamate-amine compounds depends on the alcoholising compound that is used. This can be explained by the nature of carbamate compounds formed by different alcoholising compounds.

The hydrolysis may conducted by adding water to the collected phase (B). It is understood that the addition of the water may be started at any stage after the phase (B) has been collected.

According to certain embodiments of the method according to the present invention, the hydrolysis of phase (B) is conducted by adding water after the phase (B) has been brought to a temperature of 150° C., preferably at least 160° C., more preferably at least 170° C., and preferably at most 260° C., more preferably at most 250° C., even more preferably at most 240° C.

According to certain embodiments of the method according to the present invention, the hydrolysis of phase (B) is conducted by adding water gradually adding water to the phase (B) for more than 1 hour after the gradual addition started, preferably for more than 2 hours, even more preferably for more than 3 hours and preferably at most 24 hours after the gradual addition started, more preferably at most 20 hours, even more preferably at most 15 hours.

According to certain embodiments of the method according to the present invention, the hydrolysis of phase (B) is conducted by adding water and after completing the addition of water, allowing the water and the phase (B) to react further for at least 1 hour, more preferably for at least 2 hours, even more preferably for at least 3 hours, and preferably at most 36 hours, more preferably at most 30 hours, even more preferably at most 24 hours, yet even more preferably at most 20 hours, most preferably at most 15 hours.

The amount of water needed in order to complete the hydrolysis of phase (B) is not limited. Advantageously, the amount of water is at least 10% by weight (wt. %), relative to the total weight of phase (B), more preferably at least 15 wt. %, even more preferably at least 20 wt. % and preferably at most 250 wt. %, relative to the total weight of phase (B), more preferably at most 225 wt. %, even more preferably at most 200 wt. %. It is understood that the hydrolysis reaction conditions such as pressure, time and temperature depend on the compounds in the phase (B), the relative amount of water that is used and on the scale. A person skilled in the art is able to determine suitable hydrolysis reaction conditions.

According to certain embodiments of the method according to the present invention, the hydrolysis of phase (B) is conducted in the presence of at least one hydrolysis promoting catalyst.

The hydrolysis promoting catalyst may be added to the phase (B) before the hydrolysis is started. Such a hydrolysis promoting catalyst is added in an amount of from 0.001 to 5% by weight, preferably of from 0.001 to 0.25 and most preferably from 0.001 to 0.08% by weight relative to the total weight of phase (B).

Non-limiting examples of hydrolysis promoting catalysts include metal hydroxides like LiOH, KOH, NaOH and CsOH, Lewis acids such as FeCl₃, morpholine compounds such as methyl-morpholine-N-oxide and tin compounds such as dimethyltin dilaurylmercaptide. Preferably, the hydrolysis promoting catalyst is KOH or NaOH, more preferably KOH. It is understood that the hydrolysis of phase (B) is preferably conducted in a non-oxidising atmosphere, like under a N₂ or CO₂ blanket.

In another embodiment of the method according to the present invention, phase (B1) is further subjected to a purification step by for example evaporation, distillation or ion-exchange treatments, to isolate the diamine compounds.

It is understood that this purification step may also be applied to phase (B) before it has been hydrolysed to phase (B1).

In a preferred embodiment of the method according to the present invention, phase (B1) is further subjected to a an ion-exchange treatment, thereby forming a phase (B2).

Ion exchange treatments are well-known in the art and have been extensively described.

The ion exchange treatment may be carried out by a weak cation exchanger, such as Dowex MAC-3, in the proton form with a dry capacity of 3.8 meq/ml. Preferably, the ion exchange is performed in a batch setup wherein the phase (B) is dissolved in a two-fold excess by weight of a solvent such as methanol. The mixture of phase (B) and the solvent may be mixed with the ion exchanger, preferably at room temperature during 30 minutes, the liquid phase may be removed and the ion exchanger may be further washed with a solvent such as methanol. Finally the solvent may be removed from the liquid phase via evaporation, for example at 70° C. when methanol was used as solvent. The ion exchanger may be regenerated with acidified methanol containing 5 wt % of hydrogen chloride and the acidified methanol and the remaining methanol may be removed via evaporation at 70° C.

As said, the inventors have now found that by using the at least one alcoholising compound, as detailed above, dicarbamate and carbamate-amine compounds may be partially or fully converted to diamine compounds by hydrolysis of phase (B) to a phase (B1). The inventors have further found that ion exchange treatments are able to isolate these diamine compounds from the phase (B) or (B1) in a very efficient way.

In one embodiment of the method according to the present invention, phase (B1) or (B2) is further subjected to an amine conversion step, thereby forming a recovered isocyanate compound.

As said, the diamine compounds present in phase (B1) or (B2) may be converted to their respective isocyanate compounds which can be reused for producing new PUR materials. The conversion of the amine compounds to isocyanates is well known in the art and may be performed by, for example, phosgenation of the diamine compounds by the addition of phosgene.

Another aspect of the present invention is the phase (A), phase (A1) or phase (A2) obtainable by the method according to the present invention, as detailed above.

Yet another aspect of the present invention is the phase (B), phase (B1) and phase (B2) obtainable by the method according to the present invention, as detailed above.

Yet another aspect of the present invention is a PUR material prepared from phase (A), phase (A1) or phase (A2) obtainable by the method according to the present invention, as detailed above.

Yet another aspect of the present invention is a PUR material prepared from the recovered isocyanate compound obtainable by the method according to the present invention, as detailed above.

Yet another aspect of the present invention is a PUR material prepared from phase (A), phase (A1) or phase (A2) obtainable by the method according to the present invention, as detailed above, and the recovered isocyanate compound obtainable by the method according to the present invention, as detailed above.

Yet another aspect of the present invention is a process for preparing PUR materials by reacting phase (A), phase (A1) or phase (A2) obtainable by the method according to the present invention, with at least one polyisocyanate compound.

Yet another aspect of the present invention is a process for preparing PUR materials by reacting the recovered isocyanate compound obtainable by the method according to the present invention, as detailed above, with at least one polyol compound.

Yet another aspect of the present invention is a process for preparing PUR materials by reacting phase (A), phase (A1) or phase (A2) obtainable by the method according to the present invention, as detailed above, with the recovered isocyanate compound obtainable by the method according to the present invention, as detailed above.

It is further understood that all definitions and preferences, as described above, equally apply for all further embodiments, as described below.

### EXAMPLES

The invention will be now described in more details with reference to the following examples, whose purpose is merely illustrative and not intended to limit the scope of the invention.

All contents in these examples are given in grams or parts by weight (pbw) relative to 1 part by weight of PUR material, unless stated otherwise.

The following raw materials have been used in the examples:

TABLE 1
alcoholising compounds

| | Purity | Company |
|---|---|---|
| Alcoholising compound | | |
| according to the invention | | |
| Diglycerol | 90%+ | Inovyn |
| Pentaerythritol | 98%+ | TCI |
| Xylitol | 98% | J&K scientific |
| Sorbitol | 98% | Sigma-Aldrich BVBA |
| Comparative alcoholising | | |
| compound | | |
| Glycerol | 99%+, extra pure | Acros Organics NV |
| Diethylene glycol | 99% | Sigma-Aldrich BVBA |
| Ethylene glycol | PA 99.5% | Fischer Scientific |

Polyurethane Material:

Standard PUR foam material based on TDI as polyisocyanate compound and Caradol SC48-08 as polyol compound with a hydroxyl value X of 48 mg KOH/g as determined according to standard titration methods such as ASTM 4274, ISO 14900 or ASTM E1899, wherein the PUR material had a polyol content of 55% by weight and a density of 25 kg/m³ as determined according to ISO 845.

Catalyst:

Bismuth(III)neodecanoate, available from Shepherd (Bicat 8106)—Bi content: 19.5-20.5%.

Alcoholysis Accelerator:

Pyrrolidone, purity 99.5%+available from Carl-Roth GmbH

General Procedure

A flaked PUR material with a particle size of 12 mm made from flexible PUR foam with a density of 25 kg/m³ was employed in a small scale alcoholysis reaction. 2 g of alcoholising compound (0.5 pbw), 0.4 g of alcoholysis accelerator (0.1 pbw), 0.04 g of catalyst (0.01 pbw) and a magnetic stirring rod were introduced into a 22 ml glass vial. The glass vial was placed in an aluminium block at 200° C. with magnetic stirring at 700 rpm. 4 g of PUR material (1 pbw) was manually added in three subsequent portions of 1.33 g according to dissolution, thereby forming a mixture (M₀). After dissolution of the PUR material, the alcoholising compound and the PUR material were allowed to react further during 180 minutes, thereby forming a mixture (M). The magnetic stirring bar was removed and the mixture (M) was allowed to separate into two immiscible phases, phase (A) and phase (B), while the temperature was kept at 200° C. The vial was subsequently cooled in an ice bath and centrifuged during 10 minutes at 2500 rpm. Finally the phase (A) was separated from the phase (B) via pipetting. The weight of phase (A) was measured to determine the yield of the recovered polyol compound.

### Test Methods

### NMR Protocol to Determine the Purity, the OH-Value Y and the Corrected OH-Value Y_{c}

To determine the OH-value Y and Y_{c}, phase (A) was analyzed with ¹H NMR. For this analysis 0.040 g of phase (A) was dissolved in 0.7 ml of DMSO-d₆ and analyzed with a Bruker AMX 600 MHz.

The relative weight of the different compounds is calculated by dividing the signal integral (sum of the peak areas) of the chemical shift of the characteristic protons, by the amount of equivalent protons and multiplying with the molecular weight (Mw) of the corresponding compound. The relative weight of the recovered polyol compound is calculated according to equation 1. Here, the chemical shift of the characteristic proton of the propyleneoxide (PO) units in the recovered polyol compound is taken into account, therefore equation 1 further takes into account the weight ratio of PO units in the recovered polyol compound. The relative weight of alcoholising compound, alcoholysis accelerator and diamine compound are calculated in a similar way according to equation 2, 3 and 4. The values between brackets are the respective values which are relevant for the examples below. These values include the chemical shifts of which the signal is to be integrated of for example the recovered polyol compound which is 1.05 ppm, of the alcoholising compounds which are found in the range of 4.23 ppm to 4.63 ppm, the chemical shifts of the alcoholysis accelerator pyrrolidone which are found at 2.3 and 2.1 ppm and the chemical shifts of the diamine compounds which are found at 6.56, 5.86 and 5.75 ppm; the amount of characteristic protons of the recovered polyol compound (PO units) which is equal to 3, of the alcoholysis accelerator pyrrolidone which is equal to 4 and of the diamine compounds which is equal to 3. The weight percentage of the recovered polyol compound in phase (A) (i.e. the purity) is calculated according to equation 5. The weight percentage of alcoholising compound, alcoholysis accelerator and diamine compounds are calculated according to equation 6, 7 and 8. The hydroxyl value Y of phase A was calculated according to equation 9.

$$\begin{matrix}rel . wt recovered polyol = \frac{\frac{Sum of peak areas ( 1.05 ppm )}{ Number of equiνalent protons ( 3 )} \times Mw PO}{weight ratio PO} & Eq . 1 \\ rel . wt alcoholising compound = \frac{Sum of peaka areas ( 4.23 - 4.63 ppm )}{amount hydroxyl protons} \times Mw alcoholising compound \\ & Eq . 2 \\ rel . wt alcoholysis accelerator = \frac{Sum of peak areas ( ( 2.3 ppm ) + ( 2.1 ppm )}{amount characteristic protons ( 4 )} \times Mw alcoholysis accelerator ( 85 \frac{g}{mol} ) & Eq . 3 \\ rel . wt diamine compound = \frac{( Sum of peak areas ( ( 6.56 ppm ) + ( 5.86 ppm ) + ( 5.75 ppm ) )}{amount characteristic protons ( 3 )} \times Mw diamine compound & Eq . 4 \\ wt \% recovered polyol = \frac{rel . wt recovered polyol}{total rel . wt} & Eq . 5 \\ wt \% alcoholising compound = \frac{rel . wt alcoholising compound}{total rel . wt} & Eq . 6 \\ wt \% alcoholysis accelerator = \frac{rel . wt alcoholysis accelerator}{total rel . wt} & Eq . 7 \\ wt \% diamine compound = \frac{rel . wt . diamine compound}{total rel . wt} & Eq . 8\end{matrix}$$

wherein in Eq.5-8: total rel. wt=rel. wt recovered polyol+rel. wt alcoholising compound+rel. wt alcoholysis accelerator+rel. wt diamine compound

The hydroxyl value Y of phase (A) is calculated according to equation 9 below.

OH value Y=(wt % recovered polyol×OH_value X)+(wt % alcoholising compound×OH_value of alcoholising compound)+(wt % alcoholysis accelerator×OH_value alcoholysis accelerator)+(wt % diamine compounds×OH_value diamine compounds)+(wt % carbamate_amine compounds×OH_value carbamate_amine compounds) Eq. 9

The corrected hydroxyl value Y_{c} of phase (A) only takes into account the contribution of the recovered polyol compound and the alcoholising compound and was calculated according to equation 10 below.

OH value Yc=(wt % recovered polyol×OH_value X)+(wt % alcoholising compound×OH_value alcoholising compound) Eq. 10

For the examples below this formula becomes:

OH_value=(wt % recovered polyol×48 mg KOH/g)+(wt % alcoholizing compound×OH_value alcoholising compound)

The OH-values of the alcoholising compounds, the diamine compounds and the carbamate-amine compounds may be calculated as follows: (56100*Functionality)/Molecular weight, wherein the functionality corresponds to the respective OH or the NH₂-functionality.

The OH-value of the alcoholysis accelerator pyrrolidone was determined via a standard titration method according to ASTM E1899. All OH-values can be found in Table 2 below.

It is understood that the term OH-value of the diamine and carbamate-amine compounds is actually intended to refer to their respective amine-numbers. For sake of simplicity, the term OH-value was used throughout the text.

TABLE 2

| | OH-value (in mg KOH/g) |
|---|---|
| Alcoholising compound | |
| Diglycerol | 1351 |
| Pentaerythritol | 1648 |
| Xylitol | 1845 |
| Sorbitol | 1848 |
| Glycerol | 1828 |
| Diethylene glycol | 1057 |
| Ethylene glycol | 1808 |
| Alcoholysis accelerator | |
| 2-pyrrolidone | 365 |
| Amine compounds | |
| Toluenediamine | 340 |
| Toluenecarbamateamine | 918 |

### Yield

The amount of recovered polyol compound in phase (A) was calculated according to equation 11 below.

wt. recovered polyol=wt. % recovered polyol×wt phase (A) Eq. 11

The approximate yield of the recovered polyol compound was determined by dividing the weight of the recovered polyol compound by the weight of the PUR material that was alcoholised multiplied with the original polyol compound content of the PUR material according to equation 12 below.

$$recovered polyol yield \% = \frac{wt recovered polyol}{wt PUR * polyol content PUR} \qquad Eq . 12$$

### NMR Protocol to Determine Aromatic Compound Composition of Phase (B) and Phase (B1)

Phase (B) and phase (B1) were analyzed with ¹H NMR. For this analysis 0.040 g of the phase (B) or phase (B1) was dissolved in 0.7 ml of DMSO-d₆ and analyzed with a Bruker AMX 600 MHz. The relative amounts of diamine-compounds DA (in the examples toluenediamine (TDA)), carbamate-amine compounds CA (in the examples toluene carbamate-amine TCA)) and dicarbamate compounds DC (in the examples toluene dicarbamate (TDC)) are calculated by dividing the signal integral (sum of the peak areas) of the chemical shift of the characteristic protons by the amount of equivalent protons according to equation 13, 14 and 15. The values between brackets are the respective values which are relevant for the examples below. The molar composition of the aromatic compounds in phase (B) and (B1) are calculated according to equation 16, 17 and 18.

$$\begin{matrix}rel . amount DA = \frac{Sum of peak areas ( ( 6.56 ppm ) + ( 5.86 ppm ) + ( 5.75 ppm ) )}{amount of characteristic protons ( 3 )} & Eq . 13 \\ rel . amount CA = \frac{( Sum of peak are as ( ( 6.70 ppm ) + ( 6.60 ppm ) + ( 6.50 ppm ) + ( 6.00 ppm ) + ( 5.80 ppm ) ) )}{( amount of characteristic protons ( 3 ) )} & Eq . 14 \\ rel . amount DC = \frac{Sum of peak areas ( ( 7.15 ppm ) + ( 7.05 ppm ) )}{amount of characteristic protons ( 3 )} & Eq . 15 \\ mol \% DA = \frac{rel amount DA}{rel . amount DA + rel . amount CA + rel . amount DC} & Eq . 16 \\ mol \% CA = \frac{rel . amount CA}{rel . amount DA + rel . amount CA + rel . amount DC} & Eq . 17 \\ mol \% DC = \frac{rel . amount DC}{rel . amount DA + rel . amount CA + rel . amount DC} & Eq . 18\end{matrix}$$

TABLE 3
Composition of mixture (M₀) of examples 1 to 6 and comparative
examples 7 to 9 and properties of phases (A) obtained thereof

| Compound in mixture | | | | | | | | | |
|---|---|---|---|---|---|---|---|---|---|
| (M₀) | E1 | E2 | E3 | E4 | E5 | E6 | CE7 | CE8 | CE9 |
| Alcoholising compound | | | | | | | | | |
| Diglycerol | 0.5 | 0.5 | | | | | | | |
| Pentaerythritol | | | 0.5 | | | | | | |
| Erythritol | | | | 0.5 | | | | | |
| Xylitol | | | | | 0.5 | | | | |
| Sorbitol | | | | | | 0.5 | | | |
| Glycerol | | | | | | | 0.5 | | |
| Diethylene glycol | | | | | | | | 0.5 | |
| Ethylene glycol | | | | | | | | | 0.5 |
| PUR material | 1 | 1 | 1 | 1 | 1 | 1 | 1 | 1 | 1 |
| Catalyst | 0.01 | 0.01 | 0.01 | 0.01 | 0.01 | 0.01 | 0.01 | 0.01 | 0.01 |
| Alcoholysis accelerator | 0 | 0.1 | 0.1 | 0.1 | 0.1 | 0.1 | 0.1 | 0.1 | 0.1 |
| Dissolution time | 360 | 160 | 140 | 170 | 200 | 150 | 180 | 45 | 35 |
| (in minutes) | | | | | | | | | |
| Phase (A) properties | | | | | | | | | |
| OH value Y (in mg KOH/g) | 81.0 | 73.9 | 101.5 | 130.3 | 134.7 | 151.0 | 132.9 | 206.5 | 277.8 |
| Corrected OH value Y_{c} (in | 51 | 50 | 60 | 72 | 50 | 49 | 104 | 179 | 285 |
| mg KOH/g) | | | | | | | | | |
| Wt. % recovered polyol | 96.7 | 95.9 | 92.1 | 91.8 | 89.0 | 86.4 | 92.1 | 80.3 | 81.3 |
| (purity) | | | | | | | | | |
| Yield of recovered polyol | 66 | 99 | 52 | 54 | 93 | 68 | 70 | 64 | 83 |
| in % | | | | | | | | | |
| wt. % of alcoholising | 0.4 | 0.3 | 0.9 | 1.4 | 0.7 | 1.0 | 3.0 | 13.3 | 11.1 |
| compound | | | | | | | | | |

Overall, the results in Table 3 show that the OH-value Y and the theoretical OH-value Y_{c} of the phases (A) obtained according to the method of the present invention using different alcoholising compounds having a hydroxyl functionality of at least 4 and an equivalent weight of at most 65.0 g/mol, resemble the OH-value X of the original polyol compound (i.e. 48 mg KOH/g) more closely (Examples 1-6 or E1-E6) and fulfil the requirement of having a hydroxyl value Y wherein Y≤3.5*X. When a method is using an alcoholising compound having a hydroxyl functionality of less than 4 and/or an equivalent weight of more than 65.0 g/mol, the OH-value Y and the theoretical OH-value Y_{c} are much higher (Comparative Examples 7-9 or CE7-CE9). Furthermore, the weight percent (wt. %) of the alcoholising compound remaining in the phase (A) is also significantly reduced when an alcoholising compound is used which is characterized by a hydroxyl functionality of at least 4 and by an equivalent weight of at most 65.0 g/mol while maintaining a high purity and in most cases a high yield as well. The phases (A) obtained according to the method of the present invention only contain from 0.3 to 1.0 wt % of the alcoholising compound.

### Example 10 and Comparative Example 11

A phase (B) as obtained by the method according to the present invention, where pentaerythritol was used as the alcoholising compound, was further subjected to a hydrolysis step, thereby forming a phase (B1). The hydrolysis step was performed with 200 wt. % of water containing 20 wt % of KOH, relative to the total weight of the hydrolysis reaction mixture, during 24 h at 200° C.

TABLE 4

| | Molar | Molar |
|---|---|---|
| | composition % | composition % |
| Alcoholising compound | in phase (B) | in phase (B1) |
| E10: Pentaerythritol | | |
| Toluenedicarbamates | 24.4 | 0 |
| Toluenecarbamate-amines | 50.8 | 0 |
| Toluenediamines | 24.8 | 100 |
| CE11: Glycerol | | |
| Toluenedicarbamates | 0 | 0 |
| Toluenecarbamate-amines | 56.3 | 43.6 |
| Toluenediamines | 43.7 | 56.4 |

The molar composition (in %) of the aromatic compounds in the phase (B) and the hydrolyzed phase (B1) are shown in Table 4. The aromatic compounds of the phase (B) consist mainly of toluenedicarbamates (TDC) and toluenecarbamate-amines (TCA) supplemented with a small amount of toluenediamine (TDA). The hydrolysis step results in complete hydrolysis of the carbamate functional groups to amine groups. In contrast, as a comparative example, the same hydrolysis step on phases obtained from using glycerol as alcoholising agent result in only partial hydrolysis of the carbamate functional groups.

### Example 12

A phase (A) as obtained by the method according to the present invention, where diglycerol was used as the alcoholising compound, was further subjected to an ion exchange treatment, thereby forming a phase (A2). The ion exchange was performed with a strong cation exchanger (Dowex 50WX2) in the proton form with a dry capacity of 3 meq/ml. The ion exchange is performed in a batch setup wherein phase (A) was dissolved in a two-fold excess of methanol by weight. The mixture of phase (A) and methanol was mixed with Dowex 50WX2 ion exchanger at room temperature during 30 min. Then the liquid phase was removed and the ion exchanger was washed with a two-fold excess of methanol by weight. Finally methanol was removed via evaporation at 70° C. during 3 h. Both Phase (A) and phase (A2) were analysed with ¹H NMR.

TABLE 5

| | weight | weight |
|---|---|---|
| | composition % | composition % |
| E12: diglycerol | in phase (A) | in phase (A2) |
| Toluenediamine (TDA) | 1.9 | Below detection limit |
| Diglcyerol | 0.2 | Below detection limit |
| Pyrrolidone | 1.6 | 1.0 |
| Recovered polyol compound | 96.2 | 99.0 |

The weight composition of phase (A) and the purified phase (A2) are shown in table 5. The initial phase (A) consists mainly of the recovered polyol compound supplemented with 1.9 wt % of TDA and 1.6 wt % of pyrrolidone. After ion exchange no TDA is detectable in phase (A2) indicating a practically complete removal of TDA through ion exchange. The pyrrolidone fraction in phase (A2) is also decreased to 1.0 wt % resulting in a recovered polyol compound purity of 99.0 wt %.

1. A method for alcoholising polyurethane (PUR) materials made from at least one polyol compound having a hydroxyl value X and at least one polyisocyanate compound; wherein the method comprises:
contacting the polyurethane material with at least one alcoholising compound, thereby forming a reaction mixture (M₀) and allowing the polyurethane material and the alcoholising compound to react in said reaction mixture (M₀), thereby forming a mixture (M);
allowing the mixture (M) to separate into at least two immiscible phases;
wherein at least one phase is characterized by a hydroxyl value Y wherein Y≤3.5*X; wherein at least one alcoholising compound is characterized by a hydroxyl functionality of at least 4 and by an equivalent weight of at most 65.0 g/mol; and with the proviso that when a mixture of alcoholising compounds is used, the average hydroxyl functionality of all alcoholising compounds is at least 4 and the average equivalent weight of all alcoholising compounds is at most 65.0 g/mol.

2. The method according to claim 1, wherein each of the alcoholising compounds, as detailed above, has a hydroxyl functionality of at least 4 and an equivalent weight of at most 65.0 g/mol.

3. The method according to claim 1, wherein the hydroxyl functionality of the at least one alcoholising compound is at least 4 and at most 8.

4. The method according to any one of claim 1, wherein the equivalent weight of the at least one alcoholising is at most 60.0 g/mol.

5. The method according to claim 1, wherein the at least one alcoholising compound is selected from the group consisting of diglycerol, pentaerythritol, erythritol, xylitol, sorbitol, mannitol, galactitol, arabitol, ribitol, fucitol, iditol and mixtures of two or more thereof.

6. The method according to claim 1, wherein the amount of the at least one alcoholising compound, relative to 1 part by weight (pbw) of PUR material, is equal to or less than 10 pbw.

7. The method according to claim 1, wherein the reaction mixture (M₀) further comprises at least one alcoholysis accelerator selected from the group consisting of heterocyclic amines, straight or branched chain aliphatic amines, cycloalkylamines, aromatic amines cyclic amides, and mixtures of two or more thereof.

8. The method according to claim 1, wherein the reaction mixture (M₀) further comprises at least one catalyst selected from (organo)tin and bismuth catalysts alkali metals and alkali metal hydroxides, titanium(IV) alkoxides, alkoxide complexes of lithium and potassium, tetrabutyltitanate, potassium acetate, potassium 2-ethylhexanoate, calcium 2-ethylhexanoate, bismuth(III) trifluoromethanesulfonate, iron(III) acetylacetonate, aluminium isopropoxide, dimethylimidazole, potassium adipate and urethane-reaction promoting catalysts.

9. The method according to claim 1, wherein the mixture (M) is allowed to separate into two immiscible phases, phase (A) and phase (B), wherein phase (A) comprises a recovered polyol compound and is characterized by a hydroxyl value Y wherein Y≤3.5*X.

10. The method according to claim 9, wherein the amount of the at least one alcoholising compound remaining in phase (A), relative to the total weight of phase (A), is equal to or less than 3.0 wt %.

11. The method according to claim 9, wherein the amount of the recovered polyol compound in phase (A), relative to the total weight of phase (A), is equal to or more than 86.0 wt %.

12. The method according to claim 9, wherein phase (A) is characterized by a hydroxyl value Y wherein Y≤3*X.

13. The method according to claim 9, wherein phase (A) is characterized by a corrected hydroxyl value Y_{c} wherein Y_{c}≤2*X.

14. The method according to claim 9, wherein phase (A) is further subjected to an extraction process, comprising bringing the phase (A) into contact with an extracting compound, mixing the extracting compound and the phase (A), thereby forming an extraction mixture and allowing the extraction mixture to separate into a phase (A1) and a phase (E), wherein at least one extraction compound may be used which is the same as the at least one alcoholising compounds used to form phase (A) or different.

15. The method according to claim 9, wherein phase (A) is further subjected to an ion-exchange treatment thereby forming a phase (A2).

16. The method according to claim 9, wherein phase (B) is further subjected to a hydrolysis step, thereby forming a phase (B1).

17. The method according to claim 16, wherein, phase (B1) is further subjected to a purification step selected from the group consisting of evaporation, distillation and ion-exchange treatments thereby forming a phase (B2).

18. The method according to claim 16, wherein phase (B1) is further subjected to an amine conversion step, thereby forming a recovered isocyanate compound.

19. A process for preparing polyurethane (PUR) comprising reacting phase (A) obtained by the method of claim 9 with an isocyanate compound.

20. A process for preparing polyurethane (PUR) comprising reacting a polyol with the isocyanate compound obtained by the process of claim 18.
